(19) United States
(12) Patent Application Publication
(10) Pub. No.: US 2026/0255118 A1
(43) Pub. Date: Aug. 27, 2026

(54) USER APPARATUS, COMMON APPARATUS, METHOD THEREBY, AND PROGRAM

(71) Applicant: NTT, Inc., Tokyo (JP)

(72) Inventors: Hironobu CHIBA, Tokyo (JP); Tatsuya KAKO, Tokyo (JP)

(73) Assignee: NTT, Inc., Tokyo (JP)

(21) Appl. No.: 18/877,533

(22) PCT Filed: Jun. 30, 2022
(86) PCT No.: PCT/JP2022/026205

§ 371 Date: Dec. 20, 2024

(51) Int. Cl. H04S 7/00; H04R 1/10

(52) U.S. Cl. CPC H04S 7/30; H04R 1/10

(57) ABSTRACT

An individual acoustic signal specialized for a specific user who is one of a plurality of users is presented to the specific user from an acoustic signal output device for the specific user at a timing synchronized with a common acoustic signal that is presented to the plurality of users from a common sound source.

### TECHNICAL FIELD

The present invention relates to a technique for allowing a plurality of users to listen to an acoustic signal.

### BACKGROUND ART

There is known an acoustic signal output device that allows a person to listen to individual reproduced sounds in a state in which the person can listen to ambient sound (see, for example, Non Patent Literature 1).

### CITATION LIST

### Non Patent Literature

Non Patent Literature 1:“WHAT ARE OPEN-EAR HEADPHONES?”, [online], Bose Corporation, [searched on Sep. 13, 2021], the Internet <https://www.bose.com/en_us/better_with_bose/open-ear-headphones.html>

### SUMMARY OF INVENTION

### Technical Problem

However, advantages of the acoustic signal output device that allows a person to listen to individual reproduced sounds in a state in which the person can listen to ambient sound are not sufficiently utilized.

In view of such a point, the present invention provides various services that take advantage of an acoustic signal output device that allows a person to listen to individual reproduced sounds in a state in which the person can listen to ambient sound.

### Solution to Problem

An individual acoustic signal specialized for a specific user who is one of a plurality of users is presented to the specific user from an acoustic signal output device for the specific user at a timing synchronized with a common acoustic signal that is presented to the plurality of users from a common sound source.

### Advantageous Effects of Invention

Therefore, it is possible to provide various services that take advantage of an acoustic signal output device that allows a person to listen to individual reproduced sounds in a state in which the person can listen to ambient sound.

### BRIEF DESCRIPTION OF DRAWINGS

FIG. 1 shows a configuration of a reproduction system according to an embodiment.

FIG. 2 shows a configuration of a user device and a common device according to an embodiment.

FIG. 3 is a transparent perspective view showing a configuration of an acoustic signal output device that does not completely seal an ear canal.

FIG. 4A is a transparent plan view showing a configuration of an acoustic signal output device that does not completely seal an ear canal. FIG. 4B is a transparent front view showing a configuration of an acoustic signal output device that does not completely seal an ear canal. FIG. 4C is a bottom view showing a configuration of an acoustic signal output device that does not completely seal an ear canal.

FIG. 5A is an end view taken along line 4BA-4BA of FIG. 4B. FIG. 5B is an end view taken along line 4A-4A of FIG. 4A. FIG. 5C is an end view taken along line 4BC-4BC of FIG. 4B.

FIG. 6 is a block diagram showing a hardware configuration of a user device and a common device according to an embodiment.

### DESCRIPTION OF EMBODIMENTS

Hereinafter, embodiments of the present invention will be described with reference to the drawings.

### First Embodiment

### Overall Configuration

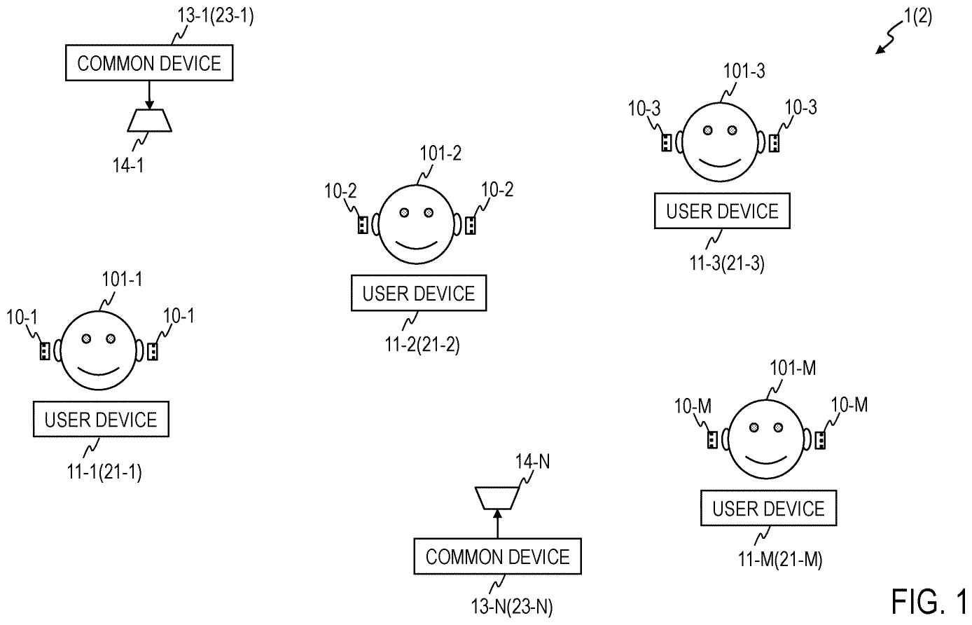

As shown in FIG. 1, a reproduction system 1 according to a first embodiment includes M user devices 11-1, . . . , and 11-M, M sets of acoustic signal output devices 10-1, . . . , and 10-M, N common devices 13-1, . . . , and 13-N, and N acoustic signal output devices 14-1, . . . , and 14-N. Here, M is an integer of 2 or more, and m=1, . . . M. N is an integer of 1 or more, and n=1, . . . N. M users 101-1, . . . , and 101-M use the reproduction system 1, and each user 101-m uses the user device 11-m and the acoustic signal output device 10-m. Note that positions and orientations of the common device 13-n and the acoustic signal output device 14-n may be fixed or variable. The user 101-m wears the acoustic signal output device 10-m and can move together with the acoustic signal output device 10-m. The user device 11-m may be moved together with the user 101-m and the acoustic signal output device 10-m or may be arranged at a position away from the user 101-m and the acoustic signal output device 10-m. The user device 11-m can communicate with the acoustic signal output device 10-m and the acoustic signal output device 10-n in a wired or wireless manner, and the acoustic signal output device 10-n can communicate with the acoustic signal output device 14-n in a wired or wireless manner.

### Acoustic Signal Output Device 10-m

The acoustic signal output device 10-m is an acoustic signal output device for the user 101-m (acoustic signal output device for a specific user). The present embodiment exemplifies the acoustic signal output device 10-m that is worn by the user 101-m without completely sealing an ear canal and emits an acoustic signal (individual acoustic signal) specialized for each user 101-m (specific user) to the ear canal of the user 101-m. Examples of the acoustic signal output device 10-m include open-ear earphones, headphones, audio sunglasses, head-mounted displays, neck speakers, bone conduction speakers, and other speakers.

### User Device 11-m

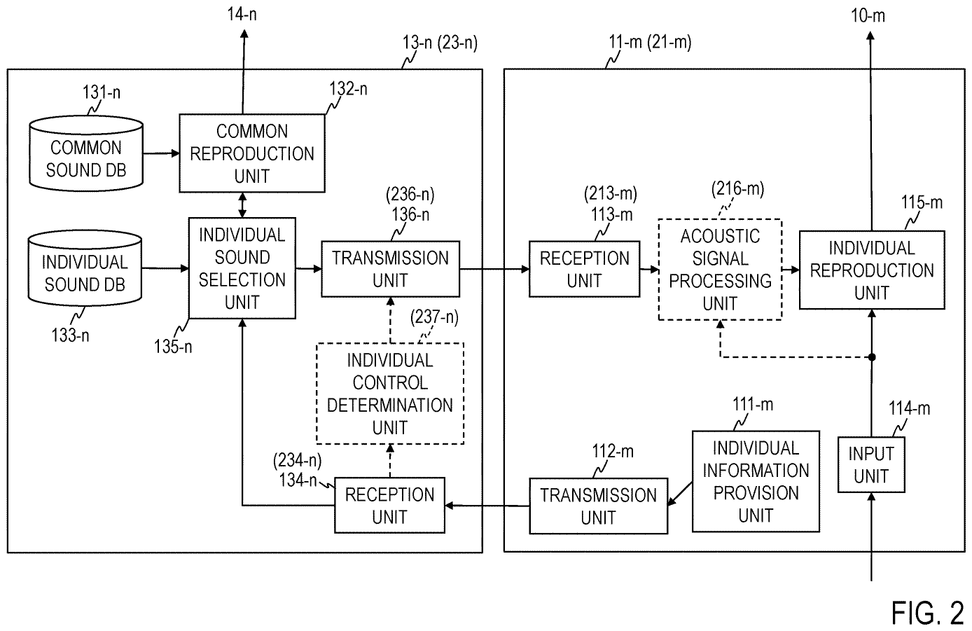

As shown in FIG. 2, the user device 11-m according to the first embodiment includes an individual information provision unit 111-m, a transmission unit 112-m, a reception unit 113-m, an input unit 114-m, and an individual reproduction unit 115-m.

### Common Device 13-n

As shown in FIG. 2, the common device 13-n according to the first embodiment includes storage units 131-n and 133-n, a common reproduction unit 132-n, a reception unit 134-n, an individual sound selection unit 135-n, and a transmission unit 136-n (output unit).

### Acoustic Signal Output Device 14-n

The acoustic signal output device 14-n (common sound source) is a device that causes a plurality of users (e.g. M users 101-1, . . . , and 101-M) to listen to a common acoustic signal. The acoustic signal output device 14-n may be any device as long as the device emits a common acoustic signal to surroundings of the user 101-m. An example of the acoustic signal output device 14-n is a speaker.

### Pre-Processing

As pre-processing, the storage unit 131-n of the common device 13-n (FIG. 2) stores a common sound database (DB) showing an acoustic signal (common acoustic signal) common (identical) to a plurality of users (e.g. M users 101-1, . . . , and 101-M). Examples of the common acoustic signal include sound such as music, voice, sound effects, and environmental sound. The storage unit 133-n stores an individual sound DB showing an acoustic signal (individual acoustic signal) specialized for each user 101-m (specific user). Examples of the individual acoustic signal include sound such as music, voice, sound effects, and environmental sound. The individual acoustic signal is a signal having content specialized for each user 101-m (specific user) and is a signal according to, for example, at least one of an attribute, preference, action, posture, orientation, position, and situation of each user 101-m (specific user). The attribute of the user 101-m is, for example, age, gender, occupation, nationality, native language, acquired language, acquired language level, residential area, family structure, income, educational background, work experience, or perceptual/cognitive characteristics. The preference of the user 101-m is, for example, a music preference, vocal preference, content, tempo preference, voice preference, or environmental sound preference. The action of the user 101-m is, for example, walking, running, rotating, stopping, sitting, standing, speaking, or being silent. The posture and orientation of the user 101-m is, for example, facing forward, facing backward, facing rightward, facing leftward, facing upward, facing downward, looking down, bending backward, an orientation of an angle of elevation/depression θ from a reference position, and an orientation of an azimuth angle τ from the reference position. The position of the user 101-m is, for example, a position of a geographic coordinate system, a position relative to the reference position, or a position relative to another user device 11-m′ (where m′≠m, m′∈{1, . . . , M}). Note that the reference position may be, for example, a fixed specific position, a moving specific position, a position of any common device 13-n, or a position of any other user device 11-m′ (where m′≠m, m′∈{1, . . . , M}). The situation of the user 101-m is, for example, participating, not participating, logging in, logging out, playing, not playing, learning, not learning, concentrated state, distracted state, fatigue state, or awake state. The individual acoustic signal is associated with, for example, registered individual information indicating the user 101-m corresponding thereto or the attribute, preference, action, posture, orientation, position, or situation of the user.

Note that the individual sound DB may be set only in the pre-processing or may be updated by subsequent update processing.

### Processing

The common reproduction unit 132-n of the common device 13-n (FIG. 2) extracts a common acoustic signal from the common sound DB stored in the storage unit 131-n and outputs an output signal for presenting the common acoustic signal (information for presenting the common acoustic signal to a plurality of users from the common sound source) (step S132-n). The output signal is an electrical signal and is supplied to the acoustic signal output device 14-n in a wired or wireless manner. In response to the supplied output signal, the acoustic signal output device 14-n (common sound source) presents (outputs) the common acoustic signal to the plurality of users. The common acoustic signal is emitted to surroundings of the user device 11-m. The user 101-m can listen to the common acoustic signal presented from the acoustic signal output device 14-n, but the volume and sound quality of the common acoustic signal that can be listened to may be different depending on a position and environment of the user 101-m. Further, depending on the position and environment of the user 101-m, the user 101-m may not be able to listen to a common acoustic signal presented from any acoustic signal output device 14-n, may be able to listen to only a common acoustic signal presented from any one acoustic signal output device 14-n, or may be able to listen to common acoustic signals presented from a plurality of acoustic signal output devices 14-n1 and 14-n2 (where n₁≠n₂, n₁, n₂∈{1, . . . , N} ) (step S14-n).

The individual information provision unit 111-m of the user device 11-m (FIG. 2) obtains and outputs individual information specialized for the user 101-m. The individual information may be set in advance, may be input in real time, or may be acquired in real time. Examples of the individual information include at least one of the attribute, preference, action, posture, orientation, position, and situation of the user 101-m. Specific examples of the attribute, preference, action, posture, orientation, position, and situation are as described above. For example, the individual information provision unit 111-m can acquire the action, posture, orientation, and the like of the user 101-m by using an acceleration information sensor, camera, or microphone, can acquire the position by using a position sensor, can detect the situation of the user 101-m by using an arithmetic device, biometric signal sensor, camera, or the like, and can detect the attribute, preference, and the like of the user 101-m by using an arithmetic device storing personal information or other devices (step S111-m). The individual information of the user 101-m output from the individual information provision unit 111-m is transmitted to the transmission unit 112-m and is transmitted from the transmission unit 112-m to the common device 13-n (step S112-m).

The reception unit 134-n of the common device 13-n receives the individual information of the user 101-m transmitted from the user device 11-m and transmits the individual information to the individual sound selection unit 135-n (step S134-n). The individual sound selection unit 135-n searches the individual sound DB of the storage unit 133-n by using the received individual information and extracts an individual acoustic signal associated with the registered individual information corresponding to the individual information. The individual sound selection unit 135-n cooperates with the common reproduction unit 132-n to generate individual reproduction control information for presenting the individual acoustic signal extracted from the individual sound DB from the acoustic signal output device 10-m at a timing synchronized with the above common acoustic signal. The individual sound selection unit 135-n transmits the individual reproduction control information to the transmission unit 136-n (step S135-n).

The transmission unit 136-n transmits the individual reproduction control information to the user device 11-m.

That is, the transmission unit 136-n (output unit) outputs information for presenting the individual acoustic signal specialized for the specific user who is one of the plurality of users to the specific user from the acoustic signal output device for the specific user at the timing synchronized with the common acoustic signal that is presented to the plurality of users from the common sound source (step S136-n).

The individual reproduction control information is received by the reception unit 113-m of the user device 11-m and is transmitted to the individual reproduction unit 115-m (step S 113-m). Based on the individual reproduction control information, the individual reproduction unit 115-m outputs an individual reproduction signal for presenting the individual acoustic signal extracted by the individual sound selection unit 135-n to the user 101-m from the acoustic signal output device 10-m at the timing synchronized with the common acoustic signal that is output from the acoustic signal output device 14-n. That is, the individual reproduction unit 115-m outputs an individual reproduction signal for presenting the individual acoustic signal specialized for the specific user who is one of the plurality of users to the specific user from the acoustic signal output device for the specific user at the timing synchronized with the common acoustic signal that is presented to the plurality of users from the common sound source. Further, the individual reproduction signal may be corrected or adjusted on the basis of information input in advance from the input unit 114-m or information input in real time (step S115-m).

The individual reproduction signal is input to the acoustic signal output device 10-m. Based on the individual reproduction signal, the acoustic signal output device 10-m outputs the individual acoustic signal extracted by the individual sound selection unit 135-n at the timing synchronized with the common acoustic signal that is output from the acoustic signal output device 14-n. Therefore, the user 101-m listens to the common acoustic signal emitted from the acoustic signal output device 14-n and the individual reproduction signal emitted from the acoustic signal output device 10-m at the timing synchronized with the common acoustic signal. In particular, the acoustic signal output device 10-m of the present embodiment is worn without completely sealing the ear canal of the user 101-m and emits the individual acoustic signal to the ear canal of the user 101-m at the timing synchronized with the common acoustic signal.

Therefore, even when wearing the acoustic signal output device 10-m, the user 101-m can listen to the common acoustic signal emitted to surroundings thereof and listen to the common acoustic signal and the individual acoustic signal in a synchronized state (step S10-m).

### Features of Present Embodiment

The user 101-m can listen to a common acoustic signal presented to a plurality of users and an individual acoustic signal specialized for each user 101-m at a synchronized timing. This makes it possible to provide various acoustic contents or an optimized acoustic content reflecting the attribute, preference, action, posture, orientation, position, situation, or the like of each user 101-m.

### Modification Example 1 of First Embodiment

In the first embodiment, the individual sound DB showing the individual acoustic signal specialized for each user 101-m is stored in the storage unit 133-n of the common device 13-n. However, the individual acoustic signal specialized for each user 101-m may be stored in each user device 11-m. In this case, the storage unit 133-n of the common device 13-n may be omitted. In this case, instead of step S135-n, the individual sound selection unit 135-n of the common device 13-n only needs to cooperate with the common reproduction unit 132-n to generate the individual reproduction control information for presenting the individual acoustic signal stored in each user device 11-m from the acoustic signal output device 10-m at the timing synchronized with the common acoustic signal. The individual reproduction control information is transmitted to the transmission unit 136-n, and the transmission unit 136-n transmits the individual reproduction control information to the user device 11-m. The individual reproduction control information is received by the reception unit 113-m of the user device 11-m and is transmitted to the individual reproduction unit 115-m (step S113-m). Further, the individual acoustic signal stored in the user device 11-m is also transmitted to the individual reproduction unit 115-m. Based on the individual reproduction control information and the individual acoustic signal, the individual reproduction unit 115-m outputs the individual reproduction signal for presenting the individual acoustic signal to the user 101-m from the acoustic signal output device 10-m at the timing synchronized with the common acoustic signal that is output from the acoustic signal output device 14-n. The individual reproduction control information is transmitted to the individual reproduction unit 115-m. The subsequent steps are the same as steps S115-m and S10-m of the first embodiment.

### Modification Example 2 of First Embodiment

In a case where the individual acoustic signal specialized for each user 101-m is stored in each user device 11-m, an individual sound selection unit may be provided in the user device 11-m. In this case, the individual sound selection unit of the user device 11-m selects an individual acoustic signal suitable for the individual information (e.g. action, posture, orientation, position, or situation) obtained by the individual information provision unit 111-m from individual acoustic signals stored in the user device 11-m and transmits the individual acoustic signal to the individual reproduction unit 115-m. Based on the individual reproduction control information and the individual acoustic signal, the individual reproduction unit 115-m outputs the individual reproduction signal for presenting the individual acoustic signal to the user 101-m from the acoustic signal output device 10-m at the timing synchronized with the common acoustic signal that is output from the acoustic signal output device 14-n. The subsequent step is the same as step S10-m of the first embodiment. In such a configuration, the individual sound selection unit 135-n may be omitted from the common device 13-n.

### Modification Example 3 of First Embodiment

Ambient sound of the user 101-m may be collected by an acoustic signal sensor such as a microphone, information regarding the ambient sound may be input to the individual reproduction unit 115-m, and the individual reproduction unit 115-m may optimize a reproduction timing of the individual acoustic signal by using the information regarding the ambient sound.

### Second Embodiment

An individual acoustic signal may be presented to the user 101-m together with a common acoustic signal presented to a plurality of users at a timing specialized for each user 101-m, or an individual acoustic signal subjected to acoustic signal processing specialized for each user 101-m may be presented to the user 101-m. Hereinafter, differences from the first embodiment will be mainly described, and matters already described will be simplified by using the same reference signs.

### Overall Configuration

As shown in FIG. 1, a reproduction system 2 according to a second embodiment includes M user devices 21-1, . . . , and 21-M, M sets of the acoustic signal output devices 10-1, . . . , and 10-M, N common devices 23-1, . . . , and 23-N, and the N acoustic signal output devices 14-1, . . . , and 14-N. The M users 101-1, . . . , and 101-M use the reproduction system 2, and each user 101-m uses the user device 21-m and the acoustic signal output device 10-m. Note that positions and orientations of the common device 23-n and the acoustic signal output device 14-n may be fixed or variable. The user 101-m wears the acoustic signal output device 10-m and can move together with the acoustic signal output device 10-m. The user device 21-m may be moved together with the user 101-m and the acoustic signal output device 10-m or may be arranged at a position away from the user 101-m and the acoustic signal output device 10-m.

### User Device 21-m

As shown in FIG. 2, the user device 21-m according to the second embodiment includes the individual information provision unit 111-m, the transmission unit 112-m, a reception unit 213-m, the input unit 114-m, the individual reproduction unit 115-m, and an acoustic signal processing unit 216-m.

### Common Device 23-n

As shown in FIG. 2, the common device 23-n according to the second embodiment includes the storage units 131-n and 133-n, the common reproduction unit 132-n, a reception unit 234-n, the individual sound selection unit 135-n, a transmission unit 236-n (output unit), and an individual control determination unit 237-n.

### Pre-Processing

Pre-processing is the same as that in the first embodiment.

### Processing

The common device 23-n performs the processing in step S132-n instead of the common device 13-n, and the acoustic signal output device 14-n performs the processing in step S14-n. The user device 21-m performs the processing in steps S111-m and S112-m instead of the user device 11-m.

The reception unit 234-n of the common device 23-n receives the individual information of the user 101-m transmitted from the user device 21-m and transmits the individual information to the individual sound selection unit 135-n and the individual control determination unit 237-n (step S134-n). The individual sound selection unit 135-n searches the individual sound DB of the storage unit 133-n by using the received individual information and extracts an individual acoustic signal associated with the registered individual information corresponding to the individual information. The individual sound selection unit 135-n cooperates with the common reproduction unit 132-n to generate individual reproduction control information for presenting the individual acoustic signal extracted from the individual sound DB from the acoustic signal output device 10-m at a timing synchronized with the above common acoustic signal. The individual sound selection unit 135-n transmits the individual reproduction control information to the transmission unit 236-n (step S135-n).

The individual control determination unit 237-n obtains individual control information for controlling signal processing specialized for the user device 21-m (specific user) by using the received individual information. An example of the signal processing specialized for the user device 21-m is processing for reproducing the individual acoustic signal in synchronization with the common acoustic signal at a timing specialized for the user device 21-m (specific user). For example, an optimum reproduction timing of the individual acoustic signal with respect to the common acoustic signal may be different depending on the attribute (e.g. age, nationality, native language, acquired language, acquired language level, or perceptual/cognitive characteristics), preference (e.g. music preference or tempo preference), action (e.g. walking, running, or stopping), posture, orientation, position (e.g. a position relative to the acoustic signal output device 14-n), and situation (e.g. concentrated state, distracted state, fatigue state, or awake state) of the user 101-m. In such a case, the individual control determination unit 237-n may obtain the individual control information in order to specify the optimum reproduction timing of the individual acoustic signal with respect to the common acoustic signal in accordance with the received individual information and reproduce the individual acoustic signal in synchronization with the common acoustic signal at the timing specialized for the user device 21-m (specific user) as described above. Another example of the signal processing specialized for the user device 21-m is acoustic signal processing specialized for the user device 21-m (specific user). For example, optimum acoustic signal processing for the individual acoustic signal may be different depending on the attribute (e.g. age, nationality, native language, acquired language, acquired language level, or perceptual/cognitive characteristics), preference (e.g. music preference or tempo preference), action (e.g. walking, running, or stopping), posture, orientation, position (e.g. a position relative to the acoustic signal output device 14-n), and situation (e.g. concentrated state, distracted state, fatigue state, or awake state) of the user 101-m. For example, in a case where the acoustic signal processing is processing of convolving a head-related transfer function (HRTF) or a head-related impulse response (HRIR) with the individual acoustic signal, the head-related transfer function or the head-related impulse response for reproducing an appropriate sense of reality, sense of distance, sense of direction, or the like may be different depending on the posture, orientation, or position of the user 101-m. Further, in a case where the acoustic signal processing is panning, volume adjustment, or the like of the individual acoustic signal, sound localization and volume that can reproduce the appropriate sense of reality, sense of distance, sense of direction, or the like may be different depending on the posture, orientation, or position of the user 101-m. For example, in a case where the acoustic signal processing is processing of causing a low-pass filter, high-pass filter, band-pass filter, or the like to act on the individual acoustic signal, an optimum passband or attenuation band may also be different depending on the attribute such as perceptual/cognitive characteristics, the preference such as a music preference, and the state such as a concentrated state, distracted state, fatigue state, or awake state of the user 101-m. In those cases, the individual control determination unit 237-n may obtain the individual control information for performing the acoustic signal processing specialized for the specific user in accordance with the received individual information. The individual control determination unit 237-n transmits the above individual control information to the transmission unit 236-n (step S237-n).

The transmission unit 236-n transmits the above individual reproduction control information and the individual control information to the user device 21-m. That is, the transmission unit 236-n (output unit) outputs information for presenting the individual acoustic signal specialized for the specific user who is one of the plurality of users to the specific user from the acoustic signal output device for the specific user at the timing synchronized with the common acoustic signal that is presented to the plurality of users from the common sound source (step S236-n).

The individual reproduction control information and the individual control information are received by the reception unit 213-m of the user device 21-m and are transmitted to the acoustic signal processing unit 216-m (step S213-m).

The acoustic signal processing unit 216-m performs signal processing on the individual acoustic signal indicated by the individual reproduction control information on the basis of the individual control information and generates and outputs new individual reproduction control information for presenting the individual acoustic signal subjected to the signal processing from the acoustic signal output device 10-m at the above timing synchronized with the common acoustic signal. For example, the acoustic signal processing unit 216-m may perform processing for reproducing the individual acoustic signal in synchronization with the common acoustic signal at the timing specialized for the user device 21-m and generate and output new individual reproduction control information for reproducing the individual acoustic signal in synchronization with the common acoustic signal at the timing specialized for the user device 21-m obtained by the processing. For example, the acoustic signal processing unit 216-m may perform the acoustic signal processing specialized for the user device 21-m on the individual acoustic signal and generate and output new individual reproduction control information for presenting the individual acoustic signal obtained by the processing from the acoustic signal output device 10-m at the above timing synchronized with the common acoustic signal. For example, the acoustic signal processing unit 216-m may perform the acoustic signal processing specialized for the user device 21-m on the individual acoustic signal and generate and output new individual reproduction control information for presenting the individual acoustic signal obtained by the processing from the acoustic signal output device 10-m at the timing specialized for the user device 21-m and at the above timing synchronized with the common acoustic signal. Further, the new individual reproduction control information may be corrected or adjusted on the basis of information input in advance from the input unit 114-m or information input in real time. The new individual reproduction control information is transmitted to the individual reproduction unit 115-m (step S216-m).

Based on the new individual reproduction control information, the individual reproduction unit 115-m outputs an individual reproduction signal for presenting the individual acoustic signal to the user 101-m from the acoustic signal output device 10-m at the timing synchronized with the common acoustic signal that is output from the acoustic signal output device 14-n. The individual reproduction signal is a signal having content specialized for the specific user based on the new individual reproduction control information. For example, the individual reproduction signal of the present embodiment may include a signal reproduced in synchronization with the common acoustic signal at the timing specialized for the user device 21-m (specific user) or may include a signal subjected to the acoustic signal processing specialized for the user device 21-m (specific user). Further, the individual reproduction signal may be corrected or adjusted on the basis of information input in advance from the input unit 114-m or information input in real time (step S115-m).

The individual reproduction signal is input to the acoustic signal output device 10-m. Based on the individual reproduction signal, the acoustic signal output device 10-m presents the individual acoustic signal to the user 101-m from the acoustic signal output device 10-m at the timing synchronized with the common acoustic signal that is output from the acoustic signal output device 14-n. In the present embodiment, for example, the individual acoustic signal is reproduced in synchronization with the common acoustic signal at the timing specialized for the user device 21-m, the individual acoustic signal subjected to the acoustic signal processing specialized for the user device 21-m is reproduced at the timing synchronized with the common acoustic signal, or the individual acoustic signal subjected to the acoustic signal processing specialized for the user device 21-m is reproduced in synchronization with the common acoustic signal at the timing specialized for the user device 21-m (step S10-m).

### Features of Present Embodiment

The user 101-m can listen to a common acoustic signal presented to a plurality of users and an individual acoustic signal specialized for each user 101-m at a synchronized timing. This makes it possible to provide various acoustic contents or an optimized acoustic content reflecting the attribute, preference, action, posture, orientation, position, situation, or the like of each user 101-m. Further, in the present embodiment, it is also possible to perform the timing and acoustic signal processing specialized for each user 101-m, which makes it possible to provide each user 101-m with an acoustic content in which the sense of reality, sense of distance, sense of direction, and the like are further optimized.

### Modification Example 1 of Second Embodiment

In the second embodiment, the individual sound DB showing the individual acoustic signal specialized for each user 101-m is stored in the storage unit 133-n of the common device 23-n. However, the individual acoustic signal specialized for each user 101-m may be stored in each user device 21-m. In this case, the storage unit 133-n of the common device 23-n may be omitted. In this case, instead of step S135-n, the individual sound selection unit 135-n of the common device 23-n only needs to cooperate with the common reproduction unit 132-n to generate the individual reproduction control information for presenting the individual acoustic signal stored in each user device 21-m from the acoustic signal output device 10-m at the timing synchronized with the common acoustic signal. The individual reproduction control information is transmitted to the transmission unit 236-n, and the transmission unit 236-n transmits the individual reproduction control information to the user device 21-m. The individual reproduction control information is received by the reception unit 213-m of the user device 21-m and is transmitted to the acoustic signal processing unit 216-m. Further, the individual acoustic signal stored in the user device 21-m is also transmitted to the acoustic signal processing unit 216-m. The acoustic signal processing unit 216-m performs signal processing on the individual acoustic signal on the basis of the individual control information and generates and outputs new individual reproduction control information for presenting the individual acoustic signal subjected to the signal processing from the acoustic signal output device 10-m at the above timing synchronized with the common acoustic signal. The new individual reproduction control information is transmitted to the individual reproduction unit 115-m. The subsequent steps are the same as steps S115-m and S10-m of the second embodiment.

### Modification Example 2 of Second Embodiment

In a case where the individual acoustic signal specialized for each user 101-m is stored in each user device 21-m, an individual sound selection unit may be provided in the user device 21-m. In this case, the individual sound selection unit of the user device 21-m selects an individual acoustic signal suitable for the individual information (e.g. action, posture, orientation, position, or situation) obtained by the individual information provision unit 111-m from individual acoustic signals stored in the user device 21-m and transmits the selected individual acoustic signal to the acoustic signal processing unit 216-m. The acoustic signal processing unit 216-m performs signal processing on the individual acoustic signal on the basis of the individual control information and generates and outputs new individual reproduction control information for presenting the individual acoustic signal subjected to the signal processing from the acoustic signal output device 10-m at the above timing synchronized with the common acoustic signal. In such a configuration, the individual sound selection unit 135-n may be omitted from the common device 23-n.

### Modification Example 3 of Second Embodiment

Ambient sound of the user 101-m may be collected by an acoustic signal sensor such as a microphone, information regarding the ambient sound may be input to the acoustic signal processing unit 216-m, and the acoustic signal processing unit 216-m may optimize a reproduction timing of the individual acoustic signal by using the information regarding the ambient sound.

### Modification Example 4 of Second Embodiment

In the second embodiment, the individual control determination unit 237-n is provided in the common device 23-n. However, the acoustic signal processing unit 216-m of the user device 21-m may have the function of the individual control determination unit 237-n. The acoustic signal processing unit 216-m only needs to perform signal processing on the individual acoustic signal on the basis of the individual information (e.g. action, posture, orientation, position, or situation) obtained by the individual information provision unit 111-m and generate and output new individual reproduction control information for presenting the individual acoustic signal subjected to the signal processing from the acoustic signal output device 10-m at the above timing synchronized with the common acoustic signal. The other aspects are as described above in the second embodiment.

### Modification Example 5 of Second Embodiment

In the second embodiment, the individual acoustic signal is a signal having content specialized for the user device 21-m (specific user). However, the individual acoustic signal common to all the users 101-1, . . . , and 101 M may be reproduced in synchronization with the common acoustic signal at the timing specialized for each user device 21-m (specific user). Alternatively, the individual acoustic signal common to all the users 101-1, . . . , and 101-M may be subjected to the acoustic signal processing specialized for each user device 21-m (specific user), and a new individual acoustic signal obtained by the processing may be reproduced at the timing synchronized with the common acoustic signal. Alternatively, the individual acoustic signal common to all the users 101-1, . . . , and 101 M may be subjected to the acoustic signal processing specialized for each user device 21-m (specific user), and a new individual acoustic signal obtained by the processing may be reproduced in synchronization with the common acoustic signal at the timing specialized for each user device 21-m (specific user). In those cases, instead of step S135-n of the second embodiment, the individual sound selection unit 135-n only needs to generate the individual reproduction control information for presenting the individual acoustic signal common to all the users 101-1, . . . , 101-M from the acoustic signal output device 10-m at the timing synchronized with the common acoustic signal and transmit the individual reproduction control information to the transmission unit 236-n.

### Example of Acoustic Signal Output Device 10-m

An example of the acoustic signal output device 10-m according to each of the above embodiments will be described. The acoustic signal output device 10-m of this example has a function of suppressing sound leakage to the outside and is particularly suitable to reproduce an acoustic signal specialized for each user device 21-m only in the user device 21-m as described in each embodiment and modification examples thereof.

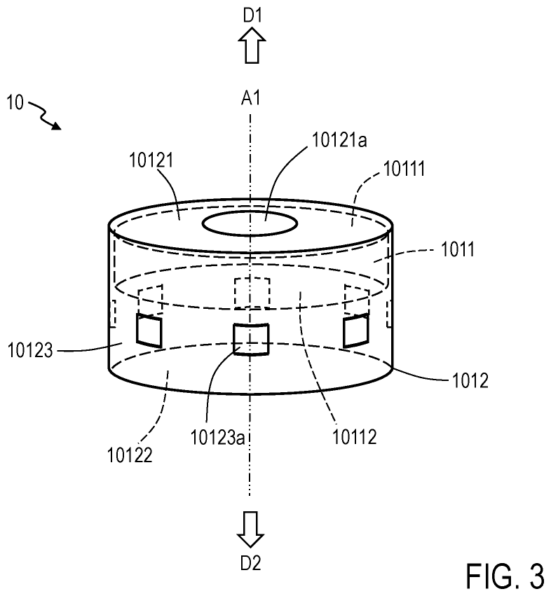

FIGS. 3, 4A to 4C, and 5A to 5C show an example of the acoustic signal output device 10-m. Hereinafter, for the sake of simplicity, each acoustic signal output device 10-m will be referred to as an acoustic signal output device 10 without distinction. Similarly, the user 101-m, the user device 11-m, and the individual reproduction unit 115-m will also be referred to as a user 101, a user device 11, and an individual reproduction unit 115.

As shown in FIGS. 3, 4A to 4C, and 5A to 5C, the acoustic signal output device 10 of this example includes a driver unit 1011 that converts an individual reproduction signal output from the individual reproduction unit 115 of the user device 11 into an acoustic signal and outputs the acoustic signal and a housing 1012 that stores the driver unit 1011 therein.

### Driver Unit 1011

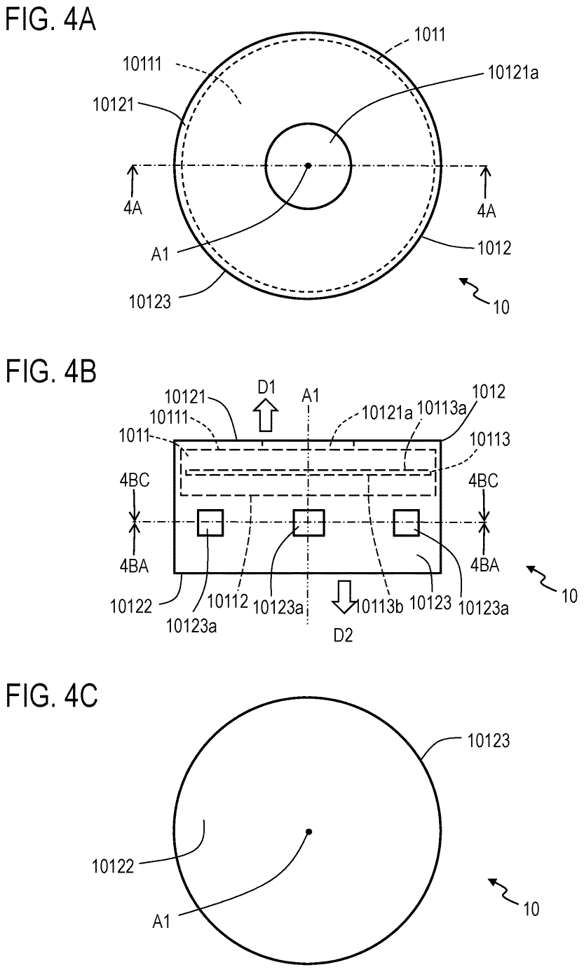

The driver unit (speaker driver unit) 1011 is a device (device having a speaker function) that emits (emits sound of) an acoustic signal AC1 (first acoustic signal) based on an input individual reproduction signal to one side (Dl direction side) and emits an acoustic signal AC2 (second acoustic signal) that is an antiphase signal (phase-inverted signal) of the acoustic signal AC1 or an approximate signal of the antiphase signal to the other side (D2 direction side). That is, the acoustic signal emitted from the driver unit 1011 to the one side (D1 direction side) will be referred to as the acoustic signal AC1 (first acoustic signal), and the acoustic signal emitted from the driver unit 1011 to the other side (D2 direction side) will be referred to as the acoustic signal AC2 (second acoustic signal). For example, the driver unit 1011 includes a diaphragm 10113 that emits the acoustic signal AC1 from one surface 10113a to the D1 direction side by vibration and emits the acoustic signal AC2 from the other surface 10113b to the D2 direction side by the vibration (FIG. 4B). By the diaphragm 10113 vibrating on the basis of an input individual reproduction signal, the driver unit 1011 of this example emits the acoustic signal AC1 from one-side surface 10111 to the D1 direction side and emits the acoustic signal AC2 that is an antiphase signal of the acoustic signal AC1 or an approximate signal of the antiphase signal from the other side 10112 to the D2 direction side. That is, the acoustic signal AC2 is secondarily emitted along with emission of the acoustic signal AC1. Note that the D2 direction (the other side) is, for example, a direction opposite to the D1 direction (one side), but the D2 direction does not need to be strictly a direction opposite to the Dl direction, and the D2 direction only needs to be different from the D1 direction. A relationship between the one side (D1 direction) and the other side (D2 direction) depends on a type and shape of the driver unit 1011. Further, depending on the type and shape of the driver unit 1011, the acoustic signal AC2 may strictly be an antiphase signal of the acoustic signal AC1, or the acoustic signal AC2 may be an approximate signal of the antiphase signal of the acoustic signal AC1. For example, the approximate signal of the antiphase signal of the acoustic signal AC1 may be (1) a signal obtained by shifting a phase of the antiphase signal of the acoustic signal AC1, (2) a signal obtained by changing (amplifying or attenuating) an amplitude of the antiphase signal of the acoustic signal AC1, or (3) a signal obtained by shifting the phase of the antiphase signal of the acoustic signal AC1 and further changing the amplitude. A phase difference between the antiphase signal of the acoustic signal AC1 and the approximate signal thereof is desirably smaller than or equal to δ₁% of one period of the antiphase signal of the acoustic signal AC1. Examples of δ₁% include 1%, 3%, 5%, 10%, and 20%. A difference between the amplitude of the antiphase signal of the acoustic signal AC1 and the amplitude of the approximate signal thereof is desirably smaller than or equal to δ₂% of the amplitude of the antiphase signal of the acoustic signal AC1. Examples of δ₂% include 1%, 3%, 5%, 10%, and 20%. Examples of the type of the driver unit 1011 include a dynamic type, a balanced armature type, a hybrid type of the dynamic type and the balanced armature type, and a capacitor type. The shapes of the driver unit 1011 and the diaphragm 10113 are not limited. In the present embodiment, for simplification of description, an example where the driver unit 1011 has a substantially cylindrical outer shape including both end surfaces and the diaphragm 10113 has a substantially disk shape will be described, but the present invention is not limited thereto. For example, the driver unit 1011 may have a rectangular parallelepiped outer shape, and the diaphragm 10113 may have a dome shape.

### Housing 1012

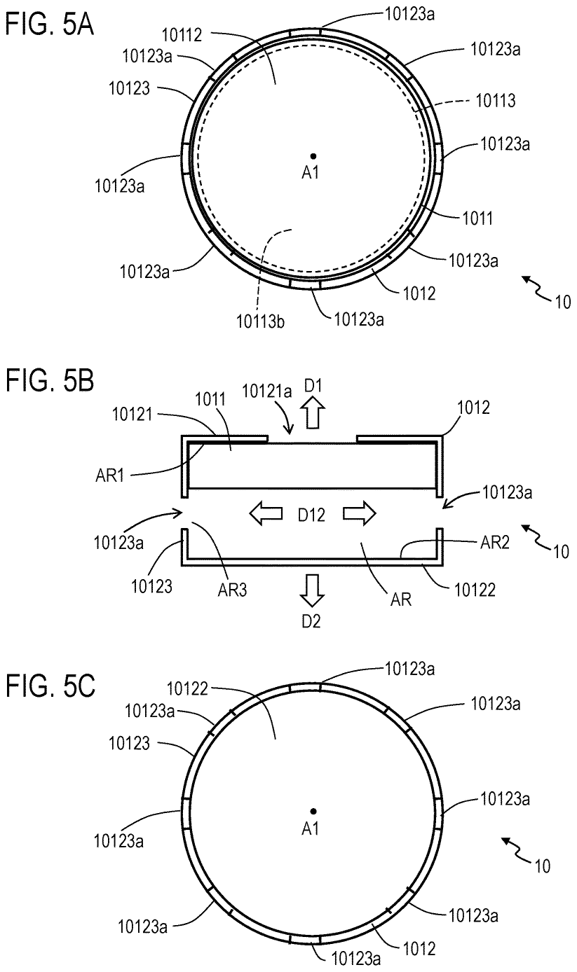

The housing 1012 is a hollow member including a wall portion on the outer side and houses the driver unit 1011 therein. For example, the driver unit 1011 is fixed to an end portion on the D1 direction side inside the housing 1012. However, the present invention is not limited thereto. Although the shape of the housing 1012 is not limited, for example, the shape of the housing 1012 is desirably rotationally symmetric (line-symmetric) or substantially rotationally symmetric about an axis A1 extending along the D1 direction. This makes it easier to provide sound holes 10123a (details will be described below) so as to reduce variation in directions of energy of sound emitted from the housing 1012. As a result, sound leakage can be easily reduced uniformly in each direction. For example, the housing 1012 includes a first end surface that is a wall portion 10121 arranged on the one side (D1 direction side) of the driver unit 1011, a second end surface that is a wall portion 10122 arranged on the other side (D2 direction side) of the driver unit 1011, and a side surface that is a wall portion 10123 surrounding a space sandwiched between the first end surface and the second end surface around the axis A1 passing through the first end surface and the second end surface (FIG. 4B, FIG. 5B). In this example, for simplification of description, an example where the housing 1012 has a substantially cylindrical shape including both end surfaces. For example, an interval between the wall portion 10121 and the wall portion 10122 is 10 mm, and the wall portions 10121 and 10122 each have a circular shape having a radius of 10 mm. However, the above is merely an example, the present invention is not limited thereto. For example, the housing 1012 may have a substantially dome shape including a wall portion at an end portion, may have a hollow substantially cubic shape, or may have another three-dimensional shape. The material of the housing 1012 is not limited. The housing 1012 may be made from a rigid body such as synthetic resin or metal or may be made from an elastic body such as rubber.

### Sound Holes 10121a and 10123a

The wall portions of the housing 1012 have a sound hole 10121a (first sound hole) for leading out the acoustic signal AC1 (first acoustic signal) emitted from the driver unit 1011 to the outside and sound holes 10123a (second sound holes) for leading out the acoustic signal AC2 (second acoustic signal) emitted from the driver unit 1011 to the outside. The sound hole 10121a and the sound holes 10123a are, for example, through holes penetrating the wall portions of the housing 1012, but the present invention is not limited thereto. As long as the acoustic signal AC1 and the acoustic signal AC2 can be led out to the outside, the sound hole 10121a and the sound holes 10123a may not be through holes.

The acoustic signal AC1 emitted from the sound hole 10121a reaches the ear canal of the user 101 and is listen to by the user 101. Meanwhile, the acoustic signal AC2 that is an antiphase signal of the acoustic signal AC1 or an approximate signal of the antiphase signal is emitted from the sound holes 10123a. A part of the acoustic signal AC2 cancels out a part (sound leakage component) of the acoustic signal AC1 emitted from the sound hole 10121a.

That is, when the acoustic signal AC1 (first acoustic signal) is emitted from the sound hole 10121a (first sound hole), and the acoustic signal AC2 (second acoustic signal) is emitted from the sound holes 10123a (second sound holes), an attenuation rate η₁₁ of the acoustic signal AC1 (first acoustic signal) at a position P2 (second point) with reference to a position P1 (first point) can be set to be smaller than or equal to a predetermined value ηₜₕ, or an attenuation amount η₁₂ of the acoustic signal AC1 (first acoustic signal) at the position P2 (second point) with reference to the position P1 (first point) can be set to be larger than or equal to a predetermined value ωₜₕ. Here, the position P1 (first point) is a predetermined point where the acoustic signal AC1 (first acoustic signal) emitted from the sound hole 10121a (first sound hole) reaches. Meanwhile, the position P2 (second point) is a predetermined point whose distance from the acoustic signal output device 10 is longer than the position P1 (first point). The predetermined value ηₜₕ is a value smaller (value lower) than an attenuation rate η₂₁ of any or specific acoustic signal (sound) due to air propagation at the position P2 (second point) with reference to the position P1 (first point). The predetermined value ωₜₕ is a value larger than an attenuation amount η₂₂ of any or specific acoustic signal (sound) due to air propagation at the position P2 (second point) with reference to the position P1 (first point). That is, the acoustic signal output device 10 of this example is designed such that the attenuation rate η₁₁ is smaller than or equal to the predetermined value ηₜₕ smaller than the attenuation rate η₂₁ or such that the attenuation amount η₁₂ is larger than or equal to the predetermined value ωₜₕ larger than the attenuation amount η₂₂. Note that the acoustic signal AC1 is propagated in air from the position P1 to the position P2 and is attenuated due to the air propagation and the acoustic signal AC2. The attenuation rate η₁₁ is a ratio (AMP₂(AC1) /AMP₁(AC1) ) of a magnitude AMP₂(AC1) of the acoustic signal AC1 at the position P2 attenuated due to air propagation and the acoustic signal AC2 to a magnitude AMP₁(AC1) of the acoustic signal AC1 at the position P1. The attenuation amount η₁₂ is a difference (|AMP₁(AC1)−AMP₂(AC1)|) between the magnitude AMP₁(AC1) and the magnitude AMP₂(AC1). Meanwhile, in a case where the acoustic signal AC2 is not assumed, any or specific acoustic signal ACₐᵣ propagating in air from the position P1 to the position P2 attenuates not due to the acoustic signal AC2 but due to the air propagation. The attenuation rate η21 is a ratio (AMP₂(ACₐᵣ)/AMP₁(ACₐᵣ)) of a magnitude AMP₂(ACₐᵣ) of the acoustic signal ACₐᵣ at the position P2 attenuated due to air propagation (attenuated not due to the acoustic signal AC2) to a magnitude AMP₁(ACₐᵣ) of the acoustic signal ACₐᵣ at the position P1. The attenuation amount η22 is a difference (|AMP₁(ACₐᵣ)−AMP₂(ACₐᵣ)|) between the magnitude AMP₁(ACₐᵣ) and the magnitude AMP₂(ACₐᵣ). Note that an example of the magnitude of the acoustic signal is sound pressure of the acoustic signal, energy of the acoustic signal, or the like. The “sound leakage component” means, for example, a component that is highly likely to arrive at a region other than the user 101 wearing the acoustic signal output device 10 (e.g. a person other than the user 101 wearing the acoustic signal output device 10) in the acoustic signal AC1 emitted from the sound hole 10121a. For example, the “sound leakage component” means a component propagating in a direction other than the D1 direction of the acoustic signal AC1. For example, a direct wave of the acoustic signal AC1 is mainly emitted from the sound hole 10121a, and a direct wave of the second acoustic signal is mainly emitted from the second sound holes. A part of the direct wave (sound leakage component) of the acoustic signal AC1 emitted from the sound hole 10121a is canceled out by interfering with at least a part of the direct wave of the acoustic signal AC2 emitted from the sound holes 10123a. However, the present invention is not limited thereto, and this cancellation may occur in waves other than direct waves. That is, the sound leakage component, which is at least one of a direct wave or reflected wave of the acoustic signal AC1 emitted from the sound hole 10121a, may be canceled out by at least one of a direct wave or reflected wave of the acoustic signal AC2 emitted from the sound holes 10123a. This makes it possible to reduce sound leakage.

### Hardware Configuration of User Device and Common Device

The user devices 11-m and 21-m and the common devices 13-n and 23-n in the embodiments are devices configured by a general-purpose or dedicated computer including, for example, a processor (hardware processor) such as a central processing unit (CPU) or a memory such as a random-access memory (RAM) or a read-only memory (ROM) executing a predetermined program. That is, the user devices 11-m and 21-m and the common devices 13-n and 23-n in the embodiments each include, for example, processing circuitry configured to implement each unit included therein. This computer may include one processor and one memory or may include a plurality of processors and a plurality of memories. The program may be installed into the computer or may be recorded in a ROM or the like in advance. Further, some or all processing units may be configured by using electronic circuitry that independently implements a processing function, instead of electronic circuitry that implements a functional configuration by reading a program, such as a CPU. Electronic circuitry forming one device may include a plurality of CPUs.

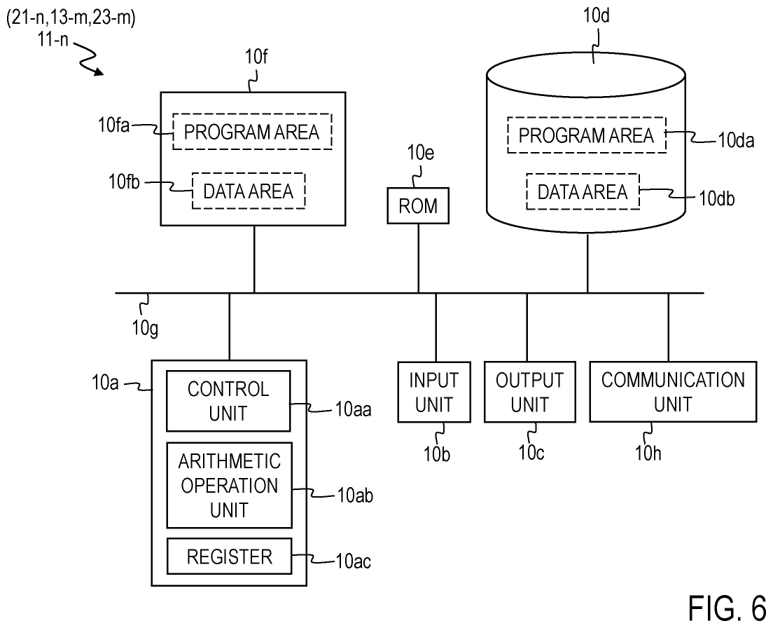

FIG. 6 is a block diagram showing a hardware configuration of the user devices 11-m and 21-m and the common devices 13-n and 23-n in the embodiments. As shown in FIG. 6, the user devices 11-m and 21-m and the common devices 13-n and 23-n of this example include a central processing unit (CPU) 10a, an input unit 10b, an output unit 10c, a random access memory (RAM) 10d, a read only memory (ROM) 10e, an auxiliary storage device 10f, a communication unit 10h, and a bus 10g. The CPU 10a of this example includes a control unit 10aa, an arithmetic operation unit 10ab, and a register 10ac, and performs various arithmetic operations in accordance with various programs read into the register 10ac. The input unit 10b is an input terminal, a keyboard, a mouse, a touch panel, or the like to which data is input. The output unit 10c is an output terminal, a display, or the like from which data is output. The communication unit 10h is a LAN card or the like controlled by the CPU 10a that has read a predetermined program. The RAM 10d is a static random access memory (SRAM), a dynamic random access memory (DRAM), or the like and has a program area 10da in which a predetermined program is stored and a data area 10db in which various kinds of data are stored. The auxiliary storage device 10f is, for example, a hard disk, a magneto-optical disc (MO), or a semiconductor memory and has a program area 10fa in which a predetermined program is stored and a data area 10fb in which various kinds of data are stored. The bus 10g connects the CPU 10a, the input unit 10b, the output unit 10c, the RAM 10d, the ROM 10e, the communication unit 10h, and the auxiliary storage device 10f such that information can be exchanged therebetween. The CPU 10a writes, into the program area 10da of the RAM 10d, the program stored in the program area 10fa of the auxiliary storage device 10f in accordance with a read operating system (OS) program. Similarly, the CPU 10a writes, into the data area 10db of the RAM 10d, the various kinds of data stored in the data area 10fb of the auxiliary storage device 10f. Addresses on the RAM 10d in which the program and the data have been written are stored in the register 10ac of the CPU 10a. The control unit 10aa of the CPU 10a sequentially reads those addresses stored in the register 10ac, reads the program and the data from the areas in the RAM 10d indicated by the read addresses, causes the arithmetic operation unit 10ab to sequentially execute arithmetic operations indicated by the program, and stores results of the arithmetic operations in the register 10ac. With such a configuration, functional configurations of the user devices 11-m and 21-m and the common devices 13-n and 23-n are implemented.

The above program can be recorded in a computer-readable recording medium. Examples of the computer-readable recording medium include a non-transitory recording medium. Examples of such a recording medium include a magnetic recording device, an optical disk, a magneto-optical recording medium, and a semiconductor memory.

The program is distributed by, for example, selling, transferring, or renting a portable recording medium such as a DVD or a CD-ROM in which the program is recorded. Further, the program may be stored in a storage device of a server computer, and the program may be distributed by transferring the program from the server computer to another computer via a network. As described above, the computer executing such a program first temporarily stores the program recorded in the portable recording medium or the program transferred from the server computer in a storage device of the computer, for example. Then, at the time of executing processing, the computer reads the program stored in the storage device thereof and executes processing according to the read program. In another mode of the program, the computer may read a program directly from the portable recording medium and execute processing according to the program, or alternatively, every time a program is transferred from the server computer to the computer, the computer may sequentially execute processing according to the received program. The above processing may also be executed by a so-called application service provider (ASP) service that implements a processing function only by an execution instruction and result acquisition without transferring a program from the server computer to the computer. Note that the program in the present embodiment includes information used for processing by an electronic computer and equivalent to the program (e.g. data that is not a direct command to the computer but has a property that defines processing of the computer).

Although the present device is configured by executing a predetermined program in the computer in each embodiment, at least part of processing content may be implemented by hardware.

### Other Modification Examples

Note that the present invention is not limited to the above embodiments. For example, each embodiment or modification example exemplifies the acoustic signal output device 10-m that is worn by the user 101-m without completely sealing an ear canal and emits an acoustic signal specialized for each user 101-m to the ear canal of the user 101-m. Such an acoustic signal output device 10-m that does not completely seal the ear canal is suitable to listen to a common acoustic signal presented to a plurality of users and an individual acoustic signal specialized for each user 101-m at a synchronized timing. However, instead of the acoustic signal output device 10-m that does not completely seal the ear canal, an acoustic signal output device that can take in a common acoustic signal emitted to the outside and present the common acoustic signal together with an individual acoustic signal to the user 101-m may be used.

In each of the above embodiments and modification examples, a common acoustic signal is reproduced from the acoustic signal output device 14-n. However, the common acoustic signal may be ambient sound such as environmental sound, natural sound, live sound, or speech sound. In such a case, the ambient sound may be collected by an acoustic signal sensor such as a microphone and be transmitted to the common device 13-n or 23-n, and the individual sound selection unit 135-n of the common device 13-n or 23-n may generate individual reproduction control information for presenting an individual acoustic signal from the acoustic signal output device 10-m at a timing synchronized with the common acoustic signal that is the ambient sound.

The individual acoustic signal may be a signal according to a relationship between the user 101-m (specific user) and a user 101-m′ (where m′∈{1, . . . , M}, m′≠m) other than the user 101-m included in the users 101-1, . . . , and 101-M (the plurality of users). For example, the individual acoustic signal that is presented to the user 101-m may be different depending on a distance between the user 101-m and the another user 101-m′, or the individual acoustic signal that is presented to the user 101-m may be different depending on the number of other users 101-m′ existing in a unit area where the user 101-m exists. Alternatively, in a case where the another user 101-m′ existing within a predetermined distance from the user 101-m and the user 101-m have a relationship registered in advance (e.g. the users are acquaintances), an individual acoustic signal different from that in the other cases may be presented to the user 101-m. The relationship between the user 101-m and the another user 101-m′ may be acquired in real time by the individual information provision unit 111-m, may be set in advance in the individual information provision unit 111-m, or may be input in real time to the individual information provision unit 111-m.

The various types of processing described above may be performed not only in time series according to the description but also in parallel or individually according to the throughput of the device that performs the processing or as necessary. In addition, it is needless to say that appropriate modifications can be made without departing from the scope of the present invention.

### Industrial Applicability

The present invention can be used, for example, for reproducing audio commentary and music for works in art museums and the like, for reproducing audio or music in movies, video games, horror attractions in amusement parks, virtual spaces, and the like, for adding sound to enhance the sense of reality in concerts, live performances, and the like, and for reproducing simultaneous interpretation voice in business, movies, sightseeing, and the like.

For example, in a case where the present invention is used in art museums or movies, there is assumed a situation in which original commentary voice or explanatory voice by a guide in a local language is reproduced as a common acoustic signal. In such a case, if the user does not acquire the language of the voice reproduced as the common acoustic signal, the user cannot understand content thereof. Here, as an individual acoustic signal, dubbing voice may be individually reproduced for each user according to the nationality, used language, and language level of the user. For example, the following use is conceivable.

Venue: English audio commentary is reproduced as a common acoustic signal.

Mr. A: Mr. A does not understand English at all, and thus, for all the audio commentary, dubbing voice in Mr. A's native language is reproduced as an individual acoustic signal for Mr. A.

Mr. B: Mr. B can understand simple English, and thus, only for a part that Mr. B cannot listen to and comprehend, dubbing voice in Mr. A's native language is reproduced as an individual acoustic signal for Mr. A.

In such an example, the individual information includes the attributes such as the native language, acquired language, and acquired language level.

Further, a type of voice or sound effect, which is an individual acoustic signal, and signal processing may be different depending on current position information of the user. Further, music may be reproduced according to the preference of the user as an individual acoustic signal.

In a case where the present invention is used in concerts, live performances, and the like, a live performance at a concert venue may be listened to by users as a common acoustic signal, and reproduced sound optimized for each user may be reproduced as an individual acoustic signal. In this example, all the users can hear the live performance in the venue. However, for example, the live performance does not include a vocal voice. In this case, different vocal sounds may be reproduced as an individual acoustic signal depending on a preset preference of the user. Alternatively, the same vocal sound is reproduced for all the users as the individual acoustic signal, but the acoustic signal processing unit reproduces the vocal sound while convoluting the head-related transfer function or the head-related impulse response corresponding to a current position of each user, which allows all the users to feel as if the vocal sound is heard from a direction of the live performance. Alternatively, the same vocal sound is reproduced for all the users as the individual acoustic signal, but the vocal sound can be reproduced only when each user is in a specific section. Such a setting may be changed in real time.

### Reference Signs List

1, 2 Reproduction system
10-m, 14-n Acoustic signal output device
11-m, 21-m User device
13-n, 23-n Common device
101-m User

1. A user device comprising processing circuitry configured to
output an individual reproduction signal for presenting an individual acoustic signal specialized for a specific user who is one of a plurality of users to the specific user from an acoustic signal output device for the specific user at a timing synchronized with a common acoustic signal that is presented to the plurality of users from a common sound source.

2. The user device according to claim 1, wherein:
the common sound source emits the common acoustic signal to surroundings of the specific user; and
the acoustic signal output device is worn by the specific user without completely sealing an ear canal of the specific user and emits the individual acoustic signal to the ear canal of the specific user.

3. The user device according to claim 1, wherein
the individual acoustic signal is a signal according to at least one of an attribute, preference, action, posture, orientation, or situation of the specific user or a relationship between the specific user and a user other than the specific user included in the plurality of users.

4. The user device according to claim 1, wherein
the individual acoustic signal includes at least one of a signal having content specialized for the specific user, a signal reproduced in synchronization with the common acoustic signal at a timing specialized for the specific user, or a signal subjected to acoustic signal processing specialized for the specific user.

5. A common device comprising processing circuitry configured to:
output information for presenting a common acoustic signal to a plurality of users from a common sound source; and
output information for presenting an individual acoustic signal specialized for a specific user who is one of the plurality of users to the specific user from an acoustic signal output device for the specific user at a timing synchronized with the common acoustic signal.

6. A method by a user device, the method comprising
an individual reproduction step of outputting an individual reproduction signal for presenting an individual acoustic signal specialized for a specific user who is one of a plurality of users to the specific user from an acoustic signal output device for the specific user at a timing synchronized with a common acoustic signal that is presented to the plurality of users from a common sound source.

7. A method by a common device, the method comprising:
a common reproduction step of outputting information for presenting a common acoustic signal to a plurality of users from a common sound source; and
an output step of outputting information for presenting an individual acoustic signal specialized for a specific user who is one of the plurality of users to the specific user from an acoustic signal output device for the specific user at a timing synchronized with the common acoustic signal.

8. A non-transitory computer-readable recording medium storing a program for causing a computer to function as the user device according to claim 1.

9. A non-transitory computer-readable recording medium storing a program
for causing a computer to function as the common device according to claim 5.
